(19) United States
(12) Patent Application Publication
(10) Pub. No.: US 2008/0045618 A1
(43) Pub. Date: Feb. 21, 2008

(54) Low viscosity UV curable ink formulations

(76) Inventor: Devdatt S. Nagvekar, Hamilton, OH (US)

Correspondence Address: HEXION SPECIALTY CHEMICALS, INC., 1600 SMITH STREET, P.O. BOX 4500, HOUSTON, TX, 77210-4500, US

(21) Appl. No.: 11/821,949

(22) Filed: Jun. 26, 2007

Related U.S. Application Data
(60) Provisional application No. 60/816,829, filed on Jun. 27, 2006.

(51) Int. Cl. C08F 2/46; C08J 3/28

(52) U.S. Cl. 522/27; 522/113; 522/28

(57) ABSTRACT

The present invention relates to active energy beam curable low viscosity compositions and inks which exhibit a low initial viscosity and rapid cure. The compositions are free of epoxy monomer and include a vinyl ether component, a mono-acrylate component, or optionally a hybrid component containing both vinyl ether and acrylate functionality, a photocation polymerization initiator, and a free-radical photoinitiator. The radiation curable formulations are particularly suitable for inkjet ink for drop-on-demand printheads.

### RELATED APPLICATION DATA

This application claims the benefit of U.S. Provisional Application Ser. No. 60/816,829 filed Jun. 27, 2006, the entire contents of which are hereby incorporated by reference.

### FIELD OF THE INVENTION

The present invention relates to active energy beam curable low viscosity ink compositions. The compositions include vinyl ether and mono-acrylate monomers, are free of epoxy monomer, and are cured utilizing a combination of a photocation polymerization initiator with a free-radical photoinitiator.

### BACKGROUND

Conventional free radicals ink formulations, although well-known and studied, do not provide adhesion to a myriad of substrates including metals and glass, largely due to shrinkage. On the other hand, cationic cure, due to low shrinkage, provides good adhesion to metals and glass. Generally for UV curable inkjet applications, the viscosity of the vehicle is an important factor for optimal printhead operation. With purely cycloaliphatic epoxy systems or acrylate systems, viscosities are generally higher which does not make them ideal in low viscosity formulations.

Certain printheads require inks of low viscosity to operate, typically between 2 to 10 cps. Generally it is difficult to formulate inks around this viscosity range, as most of the conventional acrylated functional monomers have viscosity greater than 4 cps at 25° C. Furthermore, it is difficult to have optimal physio-mechanical properties especially with monofunctional monomers without using higher functional materials whose viscosities are generally above 9 cps at 25° C.

Earlier patents, such as U.S. Pat. No. 6,310,115, describe an ink composition with radiation curable monomers containing vinyl ether and acrylate functions. However these patents use epoxy functional monomers and are not suited for a hybrid cationic and free radical polymerization.

In light of the above, there is a need in the art for low viscosity ink formulations which cure upon initiation with ultraviolet (UV) light to form polymeric films having excellent cure, adhesion, solvent resistance, and crosslink density.

### SUMMARY OF THE INVENTION

In one embodiment, there is provided a low viscosity ink formulation which includes a vinyl ether monomer component a mono-acrylate monomer component, a photocation polymerization initiator, and a free-radical photoinitiator. The formulation is free of epoxy functional monomer.

In another embodiment, there is provided a low viscosity ink formulation which includes a component containing both vinyl ether and acrylate functionality, a photocation polymerization initiator, and a free-radical photoinitiator. The formulation is free of epoxy functional monomer.

### DETAILED DESCRIPTION

The present invention provides unique and novel ink formulations, including a combination of a cationic and free radical cure. The ink formulations of the invention include low viscosity mono and difunctional vinyl ether monomers in conjunction with a mono-functional acrylate, and produce a liquid ink with good cured film properties. The composition is free of any organic solvent and is free of epoxy curable monomers. The ink formulations of the invention overcome deficiencies in prior art inkjet ink formulations which include those related to viscosity, shrinkage, adhesion and through-cure. The hybrid UV curable inkjet ink of the invention, suitable for a piezoelectric drop-on-demand printhead, is based on a photopolymerizable composition of cationic vinyl ethers in conjunction with chain transfer agents along with a free radical cure.

The present invention provides an ink system formulated with materials demonstrating viscosities from about 2 to about 10 cps, preferably from about 2 to about 7 cps and more preferably from about 4 to about 6 cps, without compromising the cure and adhesion to substrates. The ink system of the invention, includes a combination of vinyl ethers with mono-acrylates, and provides a unique way to alter formulations so that extremely low viscosity inks can be made. Furthermore the presence of oxygen atoms in the vinyl ether provides greater flexibility and also acts as an effective reactive diluent to reduce viscosity. The hybrid combination of a cationic cure, involving a chain transfer agent, and a free radical cure forms the basis of this invention not only to provide low viscosity ink formulations but also to provide adhesion to substrates as well as optimum crosslinking.

The low viscosity ink formulations of the present invention may include a vinyl ether component and a mono-acrylate component or optionally a hybrid component containing both vinyl ether and acrylate functionality, a photocation polymerization initiator, a free-radical photoinitiator and a pigment composition.

Vinyl Ether Component

The low viscosity ink formulations of the present invention include a vinyl ether component. Suitably vinyl ether components include vinyl ethers such as, for example, ethylene glycol divinyl ether, triethylene glycol divinyl ether, trimethylolpropane trivinyl ether, triethylene glycol monobutyl vinyl ether, cyclohexanedimethanol divinyl ether, hydroxybutyl vinyl ether, dodecyl vinyl ether, propenyl ether propylene carbonate, methyl vinyl ether, ethyl vinyl ether, isobutyl vinyl ether, diethylene glycol divinyl ether, butanediol divinyl ether, hexanediol divinyl ether, cyclohexanedimethanol monovinyl ether, cyclohexyl vinyl ether, 2-chloroethyl vinyl ether, 2-hydroxyethyl vinyl ether, 2,2-bis(4-vinyloxyethoxyphenyl)propane, and 1,4-bis(2-vinyloxyethoxy)benzene, specifically triethyleneglycol divinylether (Rapi-Cure® DVE-3), cyclo hexane dimethyl divinyl ether (Rapi-Cure® CHVE), 4-Hydroxybutylvinylether (Rapi-Cure® 4-HBVE), polyether cyclic polyols (Rapi-Cure® PECP), and dodecyl vinyl ether (Rapi-Cure® DDVE) (available from ISP Performance Chemicals, Wayne, N.J.), ethyleneglycol monovinyl ether (EGM-VE), ethyl vinyl ether (E-VE), propyl vinyl ether (P-VE), isobutyl vinyl ether (iB-VE), 1,6-hexanediol divinyl ether (HD-DVE), aminopropyl vinyl ether (APVE), tert-amyl vinyl ether (TAVE), butanediol divinyl ether (BDDVE), n-butyl vinyl ether (NBVE), tert-butyl vinyl ether (TBVE), cyclohexanedimethanol divinyl ether (CHDVE), cyclohexanedimethanol monovinyl ether (CHMVE), cyclohexyl vinyl ether (CVE), diethylaminoethyl vinyl ether (DEAVE), diethyleneglycol divinyl ether (DVE-2), diethyleneglycol monovinyl ether (MVE-2), dodeccyl vinyl ether (DDVE), ethyleneglycol butyl vinyl ether (EGBVE), ethyleneglycol divinyl ether (EGDVE), ethylhexyl vinyl ether (EHVE), hexanediol divinyl ether (HDMVE), 4-hydroxybutyl vinyl ether (4-HBVE), isopropyl vinyl ether (IPVE), octadecyl vinyl ether (ODVE), polyethyleneglycol-520 methyl vinyl ether (MPEG500-VE), polytetrahydrofurandivinyl ether (PTHF290-DVE), plurio-E200 divinyl ether (PEG200-DVE), n-propyl vinyl ether (NPVE), tetraethyleneglycol divinyl ether (DVE-4), triethyleneglycol divinyl ether (DVE-3), triethyleneglycol methyl vinyl ether (MTGVE), and trimethylolpropane trivinyl ether (TMPTVE) (available from BASF Aktiengesellschaft, Ludwigshafen, Germany), and hydroxylethyl vinyl ether (HEVE), diethylene glycol divinyl ether (DEG-DVE), (available from Nisso Maruzen Chemical, Tokyo, Japan) and any combination or sub-set thereof.

Other high viscosity vinyl ether monomers may also be utilized, examples of which are bis-(4-vinyl oxy butyl) isophthalate (VEctomer® 4010), bis-(4-vinyl oxy butyl) adipate (VEctomer® 4060), Tris(4-vinyloxybutyl)trimellitate (VEctomer® 5015), bis-(4-vinyl oxy butyl)hexamethylenediurethane (VEctomer® 4230), and bis[[4-(ethenyloxy)methyl]cyclohexyl]methyl]terephthalate (VEctomer® 4051) (available from Morflex Inc., Greensboro, N.C.,).

Alternately, vinyl ether based oligomers may be utilized in the formulations of the invention. An example of a vinyl ether based oligomer is VEctomer® 1312, a mixture of vinyl ether terminated aromatic ester oligomers (available from Morflex Inc., Greensboro, N.C.). Any combinations or subset of the foregoing may be utilized.

The total amount of vinyl ether monomers utilized can be from about 1 to about 85 weight percent (wt. %), preferably from about 10 to about 80 wt. %, more preferably from about 20 to about 75 wt. %, and even more preferably from about 50 to about 70 wt. % based on the total weight of the inkjet ink.

Mono-Acrylate Component

The low viscosity ink formulations of the present invention include a mono-acrylate component. Suitable mono-acrylates or their mono(meth)acrylates components include monofunctional ethylenically unsaturated monomers such as, for example, mono functional acrylate ester (CD277), monofunctional acrylate ester (CD278), acrylic ester (CD587), acrylic ester (CD585), acrylic monomer (CD420), 2-phenoxy ethyl acrylate (SR 339), cyclic trimethyolpropane formal acrylate (SR 531), isodecyl acrylate (SR 395), lauryl acrylate (SR 335), tridecyl acrylate (SR 489), stearyl acrylate (SR 257), 2(2-ethoxyethoxy) ethyl acrylate (SR 256), isooctyl acrylate (SR 440), tetrahydrofurfuryl acrylate (SR 285) (available from Sartomer, Exton, Pa.), methyl acrylate, ethyl acrylate, isopropyl acrylate, n-hexyl acrylate, allyl acrylate, 2-(2′-vinyloxy ethoxy)ethyl acrylate (VEEA) (available from Nippon Shokubai Co., Inc, Tokyo, Japan), and acrylates or their (meth)acrylates of straight chain, branched chain, or cyclic alkyl alcohols, including polyether alcohols.

Specific examples include acrylates of alcohols having more than four carbon atoms, for example lauryl acrylate and stearyl acrylate; (meth)acrylates of polyether alcohols, such as 2-(2-ethoxyethoxy)ethyl acrylate; (meth)acrylates, of cyclic alcohols, optionally containing an aliphatic linking group between the (meth)acrylate and the cyclic group, such as tetrahydrofuran acrylate (SR 285), oxetane acrylate, isobornyl acrylate (SR 506), cyclopentadiene acrylate, and the like and any sub-set thereof.

Preferred mono-acrylate components include 2-(2′-vinyloxy ethoxy)ethyl acrylate, 2(2-ethoxyethoxy)ethyl acrylate, and tetrahydrofurfuryl acrylate. Preferred mono-acrylate components can also include isobornyl acrylate. Any combinations or subset of the foregoing may be utilized.

The total amount of mono-acrylate monomers utilized can be from about 1 to about 40 weight percent (wt. %), preferably from about 1 to about 25 wt. %, more preferably from about 5 to about 15 wt. %, and even more preferably from about 3 to about 10 wt. % based on the total weight of the inkjet ink.

Component Containing Both Vinyl Ether and Acrylate Functionality

The low viscosity ink formulations of the present invention may also include a hybrid component containing both vinyl ether and acrylate functionality. These difunctional monomers are especially useful for decreasing the viscosity of curable compositions. Exemplary difunctional monomers include but are not limited to 2-(2-vinylethoxy)ethyl(meth)acrylate, 2-(2-vinylethoxy)-2-propyl(meth)acrylate, 2-(2-vinylethoxy)-3-propyl(meth)acrylate, 2-(2-vinylethoxy)-2-butyl(meth)acrylate, 2-(2-vinylethoxy)-4-butyl(meth)acrylate, 2-(2-allylethoxy) ethyl(meth)acrylate, 2-(2-allylethoxy)-2-propyl(meth)acrylate, 2-(2-allylethoxy)-3-propyl(meth)acrylate, 2-(2-allylethoxy)-2-butyl(meth)acrylate, 2-(2-allylethoxy)-4-butyl(meth)acrylate, 2-(2-vinylpropoxy)ethyl(meth)acrylate, 2-(2-vinylpropoxy)-2-propyl(meth)acrylate, 2-(2-vinylpropoxy)-3-propyl(meth)acrylate, 2-(3-vinylpropoxy)ethyl(meth)acrylate, 2-(3-vinylpropoxy)-2-propyl(meth)acrylate, 2-(3-vinylpropoxy)-3-propyl(meth)acrylate, and sub-sets and combinations comprising at least one of the foregoing. The compound 2-(2-vinylethoxy)ethyl acrylate (VEEA) is commercially available from Nippon Shokubai Co., Inc, Tokyo, Japan. Any combinations or subset of the foregoing may be utilized.

When utilized herein, the difunctional monomer may be present in an amount from about 1 to about 40 weight percent (wt. %), preferably from about 1 to about 25 wt. %, more preferably from about 5 to about 15 wt. %, and even more preferably from about 3 to about 10 wt. % based on the total weight of the inkjet ink.

Photocation Polymerization Initiator

The low viscosity ink formulations of the present invention includes a photocation polymerization initiator. The photocation polymerization initiator may contain an onium salt which effectuates highly sensitive curing characteristic with respect to the irradiation with the light. Suitable examples of oniums salt includes, for example, aryl sulfonium salt (UVI-6950), aryl sulfonium salt (UVI-6970), aryl sulfonium salt (UVI-6976), aryl sulfonium salt (UVI-6974), aryl sulfonium salt (UVI-6990) and aryl sulfonium salt (UVI 6992) (available from the Dow Chemical Company, Midland, Mich.), ADEKA Optomers aromatic sulfonium type photoinitiator (SP-150), aromatic sulfonium type photoinitiator (SP-151), aromatic sulfonium type photoinitiator (SP-170), and aromatic sulfonium type photoinitiator (SP-171) (available from Asahi Denka Kogyo, Japan), ferrocenium salt (Irgacure 261) and iodonium, (4-methylphenyl)[4-(2-methylpropyl)phenyl]-,hexafluorophosphate(1-) (Irgacure 250) (available from Ciba, Basel, Switzerland), CI-2481, CI-2624, CI-2689, and CI-2064 (available from Nippon Soda, Japan), triaryl sulfonium hexafluorophosphate (CD-1011), and Diaryliodonium hexafluoroantimonate (CD-1012) (available from Sartomer, Exton, Pa.), sulfonium salt (DTS-102), sulfonium salt (DTS-103), NAT-103, sulfonium salt (NDS-103), sulfonium salt (TPS-103), sulfonium salt (MDS-103), iodonium salt (MPI-103), diphenyl iodonium hexafluoroantimonate (BBI-103) (available from Midori Kagaku, Japan), phenyl-p-octyloxyphenyl-iodonium hexafluorantimonate (Uvacure 1600) (available from Cytec Surface Specialties, West Paterson, N.J.), and Omnicat products such as the reaction product of polyol and 10-(2-carboxymethoxy)-biphenyl-4-yl-2-isopropyl-9-oxo-9H-thioxanthen-10-ium hexafluorophosphate (Ominicat 650), a mixture of Omnicat 550 (20%) in propylene carbonate (25%) and UVR 6105 (55%) (Ominicat BL 550), 10-biphenyl-4-yl-2-isopropyl-9-oxo-9H-thioxanthen-10-ium hexafluorophosphate (Ominicat 550), a mixture of Omnicat 440 (50%) in trimethylol propane oxetane (50%) (Ominicat 445), 4,4′-dimethyl-diphenyl iodonium hexafluorophosphate (Ominicat 440), mixed triarylsulfonium hexafluorophosphate salts (45%) in propylene carbonate (55%) (Ominicat 432), and mixed triarylsulfonium hexafluorophosphate salts (Ominicat 430) (available from IGM Resins, The Netherlands). Combinations comprising more than one of the foregoing can be used.

Free-Radical Photoinitiator

The low viscosity ink formulations of the present invention include a free-radical photoinitiator. The free-radical photoinitiator is selected based on the type of colorant present and the radiation wavelength used to cure the ink. A blend of photoinitiators may be used, having peak energy absorption levels at varying wavelengths within the range of the selected radiation for cure. Preferably, the photoinitiator or photoiniator blends are sensitive to the wavelengths not absorbed, or only partially affected, by the pigments.

Suitable examples of free-radical photoinitiators include 2-benzyl-2-(dimethylamino)-4′-morpholinobutyrophenone; 2-hydroxy-2-methylpropiophenone; trimethylbenzophenone; methylbenzophenone; 1-hydroxycyclohexylphenyl ketone; isopropyl thioxanthone; 2,2-dimethyl-2-hydroxy-acetophenone; 2,2-dimethoxy-2-phenylacetophenone; 2-methyl-1-[4-(methylthio)phenyl]-2-morpholino-propan-1-one;
2,4,6-trimethylbenzyl-diphenyl-phosphine oxide; 1-chloro-4-propoxythioxanthone; benzophenone; bis(2,6-dimethoxybenzoyl)-2,4,4-trimethyl pentyl phosphine oxide; 1-phenyl-2-hydroxy-2-methyl propanone; bis(2,4,6-trimethylbenzoyl)phenylphosphine oxide; camphorquinone; and the like. Combinations and sub-sets, comprising one or more the foregoing may also be used.

Suitable commercially available photoinitiators include, but are not limited to 2-methyl-1-[4-(methylthio)phenyl]-2-(4-morpholinyl)-1-propanone (Irgacure 907), bis (2,4,6-trimethylbenzoyl)-phenylphosphineoxide (Irgacure 819), 4-(2-hydroxyethoxy)phenyl-(2-hydroxy-2-propyl)ketone (Irgacure 2959), 1-hydroxy-cyclohexyl-phenyl-ketone (Irgacure 184), 2-benzyl-2-dimethylamino-1-(4-morpholinophenyl)-butanone-1(Irgacure 369), 2-hydroxy-2-methyl-1-phenyl-propan-1-one (Darocur D1173), 2,2-dimethoxy-1,2-diphenylethan-1-one (Irgacure 651) (available from Ciba, Basel, Switzerland), diphenylmethanone, isopropyl thioxanthone (SarCure SR1124), a blend of trimethylbenzophenone and methylbenzophenone (SarCure SR1137) (available from Sartomer, Exton, Pa.), isopropylthioxanthone (ITX), and methyl benzoylformate (Genocure MBF) (available from Rahn USA corp, Aurora, Ill.). Combinations comprising more than one of the foregoing can be used.

Each of the photocation polymerization initiator and the free-radical photoinitiator are individually utilized in amounts effective to initiate polymerization in the presence of the curing radiation. The polymerization initiators may be utilized separately in an amount from about 0.5 to about 15 wt %, preferably from about 1 to about 10 wt. %, more preferably from about 2 to about 7 wt. %, and even more preferably from about 3 to about 5 wt. %, based on the total weight of the ink.

The photoinitiator composition can further contain a coinitiator or synergist, specifically an amine coinitiator such as, for example, ethyl-4-(dimethylamino)benzoate, 2-ethylhexyl dimethylaminobenzoate, and dimethylaminoethyl (meth)acrylate, and the like. Reactive amine polymerization coinitiators can be used, such as the commercially available coinitiator monofunctional amine coinitiator (CN383), difunctional amine coinitiator (CN386) (available from Sartomer, Exton, Pa.), and the like. The coinitiator can be present in the ink in an amount from about 0.5 to about 20 wt. %, specifically from about 1 to about 10 wt. %, and more specifically from about 2 to about 7 wt. %, based on the total weight of the ink.

Pigment Compositions

If desired, the radiation curable inks can be made without pigment or dyes to obtain an ink composition that is clear. The radiation curable inks further can contain a pigment composition comprising a pigment or combination of pigments to provide the desired color. Combinations of pigments and dyes can be used, provided that the thermal stability of the resulting ink is maintained.

Exemplary pigments include those having the following Color Index classifications: Green PG 7 and 36; Orange PO 5, 34, 36, 38, 43, 51, 60, 62, 64, 66, 67 and 73; Red PR 112, 149, 170, 178, 179, 185, 187, 188, 207, 208, 214, 220, 224, 242, 251, 254, 255, 260 and 264; Magenta/Violet PV 19, 23, 31, and 37, and PR 122, 181 and 202; Yellow PY 17, 120, 138, 139, 155, 151, 168, 175, 179, 180, 181 and 185; Blue PB 15, 15:3, 15:4; Black PB 2, 5 and 7; carbon black; titanium dioxide (including rutile and anatase); zinc sulfide, and the like.

Other specific pigments include, for example, IRGALITE BLUE GLVO, MONASTRAL BLUE FGX, IRGALITE BLUE GLSM, HELIOGEN BLUE L7101F, LUTETIA CYANINE ENJ, HELIOGEN BLUE L6700F, MONASTRAL GNXC, MONASTRAL GBX, MONASTRAL GLX, MONASTRAL 6Y, IRGAZIN DPP ORANGE RA, NOVAPERM ORANGE H5G70, NOVPERM ORANGE HL, MONOLITE ORANGE 2R, NOVAPERM RED HFG, HOSTAPERM ORANGE HGL, PALIOGEN ORANGE L2640, SICOFAST ORANGE 2953, IRGAZIN ORANGE 3GL, CHROMOPTHAL ORANGE GP, HOSTAPERM ORANGE GR, PV CARMINE HF4C, NOVAPERM RED F3RK 70, MONOLITE RED BR, IRGAZIN DPP RUBINE TR, IRGAZIN DPP SCARLET EK, RT-390-D SCARLET, RT-280-D RED, NOVAPERM RED HF4B, NOVAPERM RED HF3S, NOVAPERM RD HF2B, VYNAMON RED 3BFW, CHROMOPTHAL RED G, VYNAMON SCARLET 3Y, PALIOGEN RED L3585, NOVAPERM RED BL, PALIOGEN RED 3880 HD, HOSTAPERM P2GL, HOSTAPERM RED P3GL, HOSTAPERM RED E5B 02, SICOFAST RED L3550, SUNFAST MAGENTA 122, SUNFAST RED 122, SUNFAST VIOLET 19 228-0594, SUNFAST VIOLET 19 228-1220, CINQUASIA VIOLET RT-791-D, VIOLET R NRT-201-D, RED B NRT-796-D, VIOLET R RT-101-D, MONOLITE VIOLET 31, SUNFAST MAGENTA 22, MAGENTA RT-243-D, MAGENTA RT 355-D, RED B RT-195-D, CINQUASIA CARBERNET RT-385-D, MONOLITE VIOLET R, MICROSOL VIOLET R, CHROMOPTHAL VIOLET B, ORACET PINK RF, IRGALITE YELLOW 2GP, IRGALITE YELLOW WGP, PV FAST YELLOW HG, PV FAST YELLOW H3R, HOSTAPERM YELLOW H6G, PV FAST YELLOW, PALIOTOL YELLOW D1155 and IRGAZIN YELLOW 3R.

A number of different carbon black type pigments are commercially available, for example and carbon blacks such as SPECIAL BLACK 100, SPECIAL BLACK 250, SPECIAL BLACK 350, FW1, FW2 FW200, FW18, SPECIAL BLACK 4, NIPEX 150, NIPEX 160, NIPEX 180, SPECIAL BLACK 5, SPECIAL BLACK 6, PRINTEX 80, PRINTEX 90, PRINTEX 140, PRINTEX 150T, PRINTEX 200, PRINTEX U, and PRINTEX V, (available from Degussa, Düsseldorf, Germany), MOGUL L, REGAL 400R, REGAL 330, and MONARCH 900, (available from Cabot Chemical Co. Boston, Mass.), MA77, MA7, MA8, MA11, MA100, MA100R, MA100S, MA230, MA220, MA200RB, MA14, #2700B, #2650, #2600, #2450B, #2400B, #2350, #2300, #2200B, #1000, #970, #3030B, and #3230B, (available from Mitsubishi, Tokyo, Japan), RAVEN 2500 ULTRA, Carbon black 5250, and Carbon Black 5750 (available from Columbia Chemical Co., Brunswick, Ohio), and the like.

A number of titanium oxide pigments are also known. Nanostructured titania powders may be obtained, for example, from (Nanophase Technologies Corporation, Burr Ridge, Ill.), or under the trade names KRONOS® 1171 from (Kronos Titan, Dallas, Tex.). Titanium dioxide particles are prone to settling, and are therefore often surface treated. The titanium oxide particles can be coated with an oxide, such as alumina or silica. One or more layers of a metal oxide coating may be used. An exemplary example of two layers of a metal oxide coating may be a coating of alumina and a coating of silica, in either order. An exemplary example of coated titanium oxide that is easily commercially available is R960 available from E.I. du Pont de Nemours and Company, Wilmington, Del.

The titanium oxide particles may additionally be surface treated with an organic compatibilization agent such as a zirconate, titanate, silanes, silicones, and the like. Surface treatment of titanium dioxide coated with alumina includes, for example, a silicone surface treatment, preferably a dimethicone treatment using dimethicone oil or a stearic acid surface treatment. Exemplary stearic acid and alumina coated ultrafine titanium dioxide particles that are commercially available include UV-Titan M160 from Presperse, Inc., South Plainfield, N.J. Suitable silanes include trialkoxysilanes, an exemplary example being 3-(trimethoxysilyl)propyl methacrylate, available as Z6030 from Dow Chemical Company, Wilmington, Del. The corresponding acrylate may also be used.

Suitable titanium dioxides may include a decyltrimethoxysilane (DTMS) treated titanium dioxide (40 nanometer average particle diameter) from Tayca Corporation, Japan, TD3103 treated titanium dioxide available from Tayca Corporation, Japan, and titanium dioxides available from NANOTEK available from Nanophase Technologies Corporation, Romeoville, Ill. Surface-treated titanium oxide hydroxide (TiO(OH)₂) with a 30 nanometer particle size are available as STT100H™ from Titan Kogyo Ube, Yamaguchi, Japan.

The pigments are pre-dispersed prior to incorporation into the inkjet inks, generally in one or more of the radiation curable materials used in the radiation curable composition. For example, the pigment can be dispersed in a multifunctional material such as tripropylene glycol diacrylate, a propoxylated neopentyl glycol diacrylate, a hyperbranched oligomers and the like. Other additives may be present to aid in dispersion of the pigments, for example AB-type block copolymers of an alkyl acrylate and a methyl methacrylate. Generally, the pigment comprises from about 5 to about 50% of the dispersion.

The pigments generally are of a size that can be jetted from the print head without substantially clogging the print nozzles, capillaries, or other components of the print equipment. Pigment size can also have an effect on the final ink viscosity. The average particle size of the pigment is from about 0.1 to about 500 nanometers, specifically less than about 300 nanometers, and more specifically less than about 200 nanometers. For example, the pigments can have a D50 of less than or equal to 200 nanometers.

The ink is not limited to any particular color. Suitable colors include, for example cyan, magenta, yellow, black, white, orange, green, light cyan, light magenta, violet, and the like. By excluding pigment, a clear ink can also be prepared.

The amount of pigment employed in the ink will depend on the choice of pigment and the depth of color desired in the resulting cured material. In general, the pigment is used in an amount from about 1 to 30 wt. %, more preferably from about 1.5 to about 20 wt. %, and more preferably from about 2 to about 10 wt. % of the total weight of the inkjet ink

Optionally, the pigment composition can be in the form of a dispersion comprising pigment particles, a radiation curable diluent, and a dispersant to stabilize the dispersed form of the pigment particles. The radiation curable diluent can comprise epoxy groups or ethylenic unsaturation such as acrylate, vinyl ethers, or any carbon-carbon double bond unsaturation or a combination thereof, to provide crosslinking with the ethylenically unsaturated materials of the radiation curable composition. In one embodiment, the diluent can be the same as one or more of the components of the radiation curable composition.

A particular group of low viscosity monomers, suitable for use as a dispersing vehicle in the compositions of the invention, include difunctional monomers which contain an aliphatic alkyleneoxide moiety and two ethylenically unsaturated groups, or a combination of a (meth)acrylate and a vinylether group. Di- and polyfunctional compounds, suitable for use as a dispersing vehicle in the compositions of the invention, are selected so as to provide the desired viscosity and crosslink density. Suitable difunctional ethylenically unsaturated monomers include, for example, di(meth)acrylates of diols and polyetherdiols, including glycols and polyglycols, such as propylene glycol and polypropylene glycols. Repeating units of glycols including di-, tri- and higher glycols can be used. Other suitable di(meth)acrylates include the di(meth)acrylate of 1,4-butanediol (SR 213), 1,3-butanediol, neopentylglycol, propoxylated neopentyl glycol (SR 9003), diethylene glycol (SR 230), hexanediol, dipropylene glycol (SR 508), tripropylene glycol (SR 306), triethylene glycol (SR 272), polyethylene glycol (SR 259), alkoxylated hexane diols (CD 560 and CD 564), neopentylglycol (SR 247), tetraethylene glycol (SR 268) and aloxylated aliphatic diacrylate (SR 9209) (available from Sartomer, Exton, Pa.). Divinyl and/or diallyl compounds may also be used. Dispersing vehicles useful in the compositions of the invention may also include, in addition to the above, an ethylenically unsaturated oligomers with a functionality of 2 or more. Combinations comprising at least one of the foregoing difunctional compounds can be used.

Use of a dispersant improves the stability of the pigment dispersion, and preferably substantially reduces or eliminates agglomeration or settling of the pigment particles during manufacture of the ink, storage, and/or use. The dispersant can be selected from a variety of materials including silicones, and other monomers or oligomers having good wetting properties for the pigment.

Suitable pigments and pigment dispersions can be obtained from a variety of commercial sources including Abbey Masterbatch Ltd., Ashton under Lyne UK; Small Products LTD., UK; Aellora, Keene, N. H.; Choksi Pigments, Gujarat, India; Noveon Hilton Davis, Inc. of Cincinnati, Ohio; Penn Color Inc. of Doylestown, Pennsylvannia; Sharda Dye Chem, Gujarat, India; Spectrum Dyes & Chemical Gujarat, India; Taiwan Nanotechnology Corporation, Taiwan; and Tianjin Angel Trading Development Co., Ltd. Tianjin, China; etc.

In a preferred embodiment, the ink formulations of the invention can include a divinyl ether such as 3,6,9,12-tetraoxatetradeca-1,13-diene, 4-hydroxybutyl vinyl ether, a mono functional acrylate, a pigment dispersion in diacrylate monomer and photoinitiators based on cationic and free radical provides low viscosity for the inks.

Other Additives

Other additives can optionally be included in the low viscosity ink formulations. Surfactants such as silicones, acrylics, or fluorosurfactants, each of which can be unsaturated or saturated can be included. Surfactants can be used to lower the surface tension of the composition to improve wettability characteristics. Examples of exemplary surfactants include polyether modified polydimethylsiloxane (BYK 377) (available from BYK Chemie USA Inc., Wallingford, Conn.), silicone hexaacrylate (Ebecryl 1360) or silicone diacrylate (Ebecryl 350) from (Cytec Industries, West Paterson, N.J.) and aliphatic silicone acrylate (CN 9800) (available from Sartomer, Exton, Pa.).

### PREFERRED EMBODIMENTS

In a preferred embodiment a low viscosity ink composition may be made from a dual monomer composition of a vinyl ether blend monomer of Triethyleneglycol Divinylether (Rapicure® DVE-3) with 4-Hydroxybutylvinylether (Rapicure® 4-HBVE) and a mono-acrylate monomer of 2(2-Ethoxyethoxy) ethyl acrylate (SR 256) combined with dual photo-initiators of a photocation polymerization initiator of methyl benzoylformate (Genocure MBF) with mixed aryl sulfonium hexafluoro phosphate salt (UVI Cure 6992) and a free-radical photoinitiator of isopropylthioxanthone (ITX). This embodiment may include a surfactant, an exemplary one such as polyether modified polydimethylsiloxane (BYK 377), and a colorant. Other exemplary mono-acrylate monomers for this embodiment include 2-(2′-Vinyloxy Ethoxy)Ethyl acrylate (VEEA) and Tetrahydrofurfuryl acrylate (THF-A, SR 285). Other exemplary photocation polymerization initiators for this embodiment include Mixed Aryl sulfonium hexafluoroantimonate salt (UVI Cure 6976) or Phenyl-p-octyloxyphenyl-iodonium hexafluoro antimonite (Uvacure 1600).

In a preferred embodiment a low viscosity ink composition may be made from a dual monomer composition of a vinyl ether blend monomer of Triethyleneglycol Divinylether (Rapicure® DVE-3) with 4-Hydroxybutylvinylether (Rapicure® 4-HBVE) and a mono-acrylate monomer isobornyl acrylate (SR 506) combined with dual photo-initiators of a photocation polymerization initiator of methyl benzoylformate (Genocure MBF) with mixed aryl sulfonium hexafluoro phosphate salt (UVI Cure 6992) and a free-radical photoinitiator of isopropylthioxanthone (ITX). This embodiment may include a surfactant, an exemplary one such as polyether modified polydimethylsiloxane (BYK 377), and a colorant. Other exemplary mono-acrylate monomers for this embodiment include ethyl acrylate (SR 256).

In a preferred embodiment a low viscosity ink composition may be made from a dual monomer composition of a vinyl ether blend monomer of Triethyleneglycol Divinylether (Rapicure® DVE-3) with 4-Hydroxybutylvinylether (Rapicure® 4-HBVE) and a mono-acrylate monomer isobornyl acrylate (SR 506) combined with dual photo-initiators of a photocation polymerization initiator of methyl benzoylformate (Genocure MBF) with iodonium, (4-methylphenyl)[4-(2-methylpropyl)phenyl]-,hexafluorophosphate(1-) (Irgacure 250) and a free-radical photoinitiator of isopropylthioxanthone (ITX). This embodiment may include a surfactant, an exemplary one such as polyether modified polydimethylsiloxane (BYK 377), and a colorant. Other exemplary mono-acrylate monomers for this embodiment include ethyl acrylate (SR 256).

In a preferred embodiment a low viscosity ink composition can be made from a dual monomer composition of a vinyl ether blend monomer of Triethyleneglycol Divinylether (Rapicure DVE-3) with 4-Hydroxybutylvinylether (Rapicure 4-HBVE) and a mono-acrylate monomer of 2-(2′-Vinyloxy Ethoxy)Ethyl acrylate (VEEA) combined with dual photo-initiators of a photocation polymerization initiator of methyl benzoylformate (Genocure MBF) with mixed aryl sulfonium hexafluoro phosphate salt (UVI Cure 6992) and a free-radical photoinitiator of isopropylthioxanthone (ITX). This embodiment may include a surfactant, an exemplary one such as polyether modified polydimethylsiloxane (BYK 377), and a colorant.

In order to provide a better understanding of the present invention including representative advantages thereof, the following non-limiting examples are offered. It is understood that the following non-limiting examples are for illustrative purposes and should not be regarded as limiting the scope of the invention to any specific materials or conditions.

### EXAMPLES

Procedure for Adhesion Testing

Adhesion: Crosshatch adhesion was determined according to the following procedure. A film of an inkjet ink is prepared at a thickness of 9 micrometers using a #6 Mayer rod, cured using a mercury vapor lamp at a dose of 700 mJ/cm², H lamp, and conditioned for 16-24 hours at 25° C. (±2° C.), and at a relative humidity of 50% (±5%). A series of 6 parallel incisions from about 2 to 2.5 cm in length and spaced 2.0 mm apart is made in the film using a suitable cutting tool such as a Gardco PA-2000 cutting tool with 6 parallel blades, followed by a second set of incisions of the same dimensions and rotated 90° to the first set. In this way a crosshatch pattern is made, and the crosshatched surface is cleaned using a brush or compressed air to remove particulate contaminants. A length of tape from about 7 to 8 cm of a suitable tape, such as 3M 610 tape by 3M Corporation, is applied to the crosshatched area and rubbed smoothed out to remove any trapped air bubbles, and to ensure a good contact. The tape is then pulled off within 90 seconds (+30 seconds) upon application to the crosshatched area. The crosshatch areas are then quantified according to the method of ASTM D3359 where “49” refers to the best adhesion and “0” refers to the worst adhesion.

Procedure for Viscosity

Viscosity: The viscosity of the ink was determined using a Haake Roto Visco 1 and a TCP/P—Peltier Temperature Control Unit. The viscosity was obtained at a temperature of 25° C. and the results are provided in centipoises (cP). The degree of cure at the face of the film opposite to the surface (Bottom residual vinyl unsaturation (RVU) %) is obtained by pulling the cured film from the surface with the 600 tape from 3M and facing the surface of the ink film to the diamond attenuated total reflectance (ATR) crystal while a spectrum is obtained.

Procedure for MEK rubs

MEK Rub test: The MEK (methyl ethyl ketone) rub technique is a method for assessing the solvent resistance of a cured inkjet ink by incorporating ASTM D4752 into ASTM D3732-82. The ink to be cured is applied to a polyester (PET), polycarbonate (PC) or vinyl substrate using #6 Mayer Rod. The coated film was cured at a dose of 700 mJ/cm² using a Hanovia H lamp, max power: 300 Watts/inch, (dosage recorded by PowerMap). Test areas on the ink film surface of at least 2 inches long are selected for testing. The ball end of a hammer wrapped in two thicknesses of cheesecloth is saturated to a dripping wet condition with the MEK. The wet ball end is rubbed across the 2-inch portion of the cured film, one forward and one backward movement constitutes a single rub. The surface is rubbed until the ink has been completely removed from any point along the test area.

Degree of Cure

Degree of cure: The degree of cure of the ink was determined by measuring percent reacted vinyl ether peak (% RVU) of the cured ink using a Nicolet 860 Magna FT-IR bench equipped with a Durasampl IR II ATR (Diamond). A drop of liquid inkjet ink is placed onto the diamond ATR crystal and a spectrum of the unreacted liquid ink is obtained. A cured film of ink is prepared for spectral analysis by forming a film of ink having a thickness of about 7-10 micrometers using #6 Mayer rod drawdowns substrate. The ink film is then cured using a Hanovia H lamp, max power: 300 Watts/inch, at a dose of 700 mJ/cm². The cured ink film is removed from the substrate and the top surface and the bottom surface of the film (the face adjacent to the substrate) is measured for degree of cure.

The degree of cure at the top surface of the film (“TOP RVU %”) is determined by cutting a piece of ink film (about ½″×½″) and having the top surface of the film face the diamond ATR crystal while a spectrum is obtained.

The degree of cure at the face of the film opposite to the surface (Bottom RVU %) is obtained by facing the bottom surface of the film to the diamond ATR crystal while a spectrum is obtained.

The carbon-carbon bond of the vinyl ether functionality is observed in the liquid ink at about 1640 cm⁻¹. The area of the peak is measured starting from about 1679 cm⁻¹ to 1564 cm⁻¹. The presence of a peak at 1640 cm⁻¹ for the cured ink top surface is also measured for surface area according to the procedure for the liquid ink. The area of a peak at 1640 cm⁻¹ is also obtained for the cured ink bottom surface. The % RVU is then calculated using the formulas below:
% RVU of Top Surface=[Area 1640 cm⁻¹ top/Area 1640 cm⁻¹ liquid)]×100
% RVU of Bottom Surface=[Area 1640 cm⁻¹ bottom/Area 1640 cm⁻¹ liquid)]×100

The degree of cure is calculated using the following formulas:
% cure for Top Surface=[1−(Area 1640 cm⁻¹ top/Area 1640 cm⁻¹ liquid)]×100
% cure for Bottom Surface=[1−(Area 1640 cm⁻¹ bottom/Area 1640 cm⁻¹ liquid)]×100

In the following tables ND indicates “not determined”, NP indicates “no peaks”, and CD indicates “cannot be determined.”

Non-limiting examples of cyan ink formulations, prepared in accordance with the present invention, are shown in Table 1. Film properties of these cyan ink formulations appear in Table 2.

Non-limiting examples of black ink formulations, prepared in accordance with the present invention, are shown in Table 3. Film properties of these black ink formulation appear in Table 4.

Non-limiting examples of cyan ink formulations, cured with mixed aryl sulfonium hexafluoro phosphate salt UVI-6992, prepared in accordance with the present invention are shown in Table 5. Film properties of these cyan ink formulations appear in Table 6.

Non-limiting examples of magenta ink formulations, cured with mixed aryl sulfonium hexafluoro phosphate salt UVI-6992, prepared in accordance with the present invention, are shown in Table 7. Film properties of these magenta ink formulations appear in Table 8.

Non-limiting examples of yellow ink formulations, cured with mixed aryl sulfonium hexafluoro phosphate salt UVI-6992, prepared in accordance with the present invention, are shown in Table 9. Film properties of these yellow ink formulations appear in Table 10.

Non-limiting examples of black ink formulations cured with mixed aryl sulfonium hexafluoro phosphate salt UVI-6992, prepared in accordance with the present invention, are shown in Table 11. Film properties of these black ink formulations appear in Table 12.

Non-limiting examples of cyan ink formulations cured with iodonium, (4-methylphenyl) [4-(2-methylpropyl)phenyl]-,hexafluorophosphate(1-) photoinitiator Irgacure 250, prepared in accordance with the present invention, are shown in Table 13. Film properties of these cyan ink formulations appear in Table 14.

Non-limiting examples of magenta ink formulations cured with iodonium, (4-methylphenyl)[4-(2-methylpropyl)phenyl]-,hexafluorophosphate(1-) photoinitiator Irgacure 250, prepared in accordance with the present invention, are shown in Table 15. Film properties of these magenta ink formulations appear shown in Table 16.

Non-limiting example yellow ink formulations cured with iodonium, (4-methylphenyl)[4-(2-methylpropyl)phenyl]-,hexafluorophosphate(1-) photoinitiator Irgacure 250, prepared in accordance with the present invention, are shown in Table 17. Film properties of these Yellow ink formulations appear in Table 18.

Non-limiting example black ink formulations cured with iodonium, (4-methylphenyl)[4-(2-methylpropyl)phenyl]-,hexafluorophosphate(1-) photoinitiator Irgacure 250, prepared in accordance with the present invention, are shown in Table 19. Film properties of these black ink formulations appear in Table 20.

TABLE 1
Formulations of Low Viscosity Cyan Ink

| Raw Material | N1 | N2 | N3 | N4 | N5 | N6 | N7 | N8 | N9 |
|---|---|---|---|---|---|---|---|---|---|
| Triethyleneglycol Divinylether | 61 | 61 | 61 | 61 | 61 | 61 | 61 | 61 | 61 |
| (Rapicure DVE-3) | | | | | | | | | |
| 4-Hydroxybutylvinylether | 5 | 5 | 5 | 5 | 5 | 5 | 5 | 5 | 5 |
| (Rapicure 4-HBVE) | | | | | | | | | |
| 2-(2′-Vinyloxy Ethoxy)Ethyl acrylate | 10 | 10 | 10 | | | | | | |
| (VEEA) | | | | | | | | | |
| 2(2-ETHOXYETHOXY) ETHYL | | | | 10 | 10 | 10 | | | |
| ACRYLATE (SR 256) | | | | | | | | | |
| TETRAHYDROFURFURYL | | | | | | | 10 | 10 | 10 |
| ACRYLATE (THF-A, SR 285) | | | | | | | | | |
| Polyether modified | 0.5 | 0.5 | 0.5 | 0.5 | 0.5 | 0.5 | 0.5 | 0.5 | 0.5 |
| polydimethylsiloxane (BYK 377) | | | | | | | | | |
| Methyl benzoylformate | 3.5 | 3.5 | 3.5 | 3.5 | 3.5 | 3.5 | 3.5 | 3.5 | 3.5 |
| (Genocure MBF) | | | | | | | | | |
| Phenyl-p-octyloxyphenyl-iodonium | 4 | | | 4 | | | 4 | | |
| hexafluoro antimonate | | | | | | | | | |
| (Uvacure 1600) | | | | | | | | | |
| Mixed Aryl sulfonium | | 4 | | | 4 | | | 4 | |
| hexafluoroantimonate salt | | | | | | | | | |
| (UVI Cure 6976) | | | | | | | | | |
| Mixed Aryl sulfonium hexafluoro | | | 4 | | | 4 | | | 4 |
| phosphate salt | | | | | | | | | |
| (UVI Cure 6992) | | | | | | | | | |
| Isopropylthioxanthone | 1 | 1 | 1 | 1 | 1 | 1 | 1 | 1 | 1 |
| (ITX) | | | | | | | | | |
| Cyan Dispersion NN-BBD15-1 (20% | 15 | 15 | 15 | 15 | 15 | 15 | 15 | 15 | 15 |
| cyan pigment in tripropylene glycol | | | | | | | | | |
| diacrylate) | | | | | | | | | |
| Total | 100.0 | 100.0 | 100.0 | 100.0 | 100.0 | 100.0 | 100.0 | 100.0 | 100.0 |
| Viscosity @ 25° C. | 5.2 | 4.7 | 5.2 | 5.1 | 5.1 | 4.8 | 5.1 | 5.0 | 5.1 |

Table 2 shows that formulation N6 was exemplary, as determined by good adhesion on a PET (polyester terephthalate) substrate, good crosslink density, low viscosity and excellent cure for the top surface. The ink was cured at 300 Watt/in mercury vapor bulb at a dose of 700 mJ/cm2 via Hanovia cure unit. The adhesion was determined via a cross hatch tool and the crosslink density was determined based on the number of MEK rubs.

TABLE 2
Films Properties for Cyan ink formulas upon curing

| Films | | | | | | | | | |
|---|---|---|---|---|---|---|---|---|---|
| Properties | N1 | N2 | N3 | N4 | N5 | N6 | N7 | N8 | N9 |
| Surface Tack | Tack | Tack | Tack | Tack | Tack | Tack | Tack | Tack | Tack |
| | free | free | free | free | free | free | free | free | free |
| MEK Rubs | 3 | 11 | 11 | 3 | 1 | 3 | 4 | 6 | 5 |
| X-hatch | 3 | 2 | 0 | 30 | 7 | 49 | 43 | 0 | 0 |
| Adhesion | | | | | | | | | |
| % Cure (Top | ND | ND | ND | 95.7 | ND | 97.1 | 97.3 | ND | ND |
| Surface) | | | | | | | | | |
| % Cure | ND | ND | ND | Film | ND | Film | Film | ND | ND |
| (Bottom | | | | cannot be | | cannot | cannot | | |
| Surface) | | | | peeled | | be | be | | |
| | | | | | | peeled | peeled | | |

A black ink was prepared based upon the results of the N6 cyan ink, and its cured film properties were determined. A representative example of a Low viscosity black ink is shown below in Table 3, and its film properties are shown in Table 4.

TABLE 3
Formulation of Low Viscosity Black Ink

| Raw Material | N10 |
|---|---|
| Triethyleneglycol Divinylether (Rapicure DVE-3) | 65.2 |
| 4-Hydroxybutylvinylether Rapicure (4-HBVE) | 5 |
| 2(2-ETHOXYETHOXY) ETHYL ACRYLATE (SR 256) | 10 |
| Polyether modified polydimethylsiloxane (BYK 377) | 0.1 |
| Methyl benzoylformate (Genocure MBF) | 3.5 |
| Mixed Aryl sulfonium hexafluoro phosphate salt (UVI Cure 6992) | 4 |
| Isopropylthioxanthone(ITX) | 1 |
| Black Dispersion NN-KAA07-1 (20% black pigment in | 11.2 |
| tripropylene glycol diacrylate) | |
| Total | 100 |
| Viscosity @ 25° C. | 4.3 |

TABLE 4
Films Properties for Black Ink Formula Upon Curing

| Films Properties | N10 |
|---|---|
| Surface Tack | Tack free |
| MEK Rubs | 2 |
| X-hatch Adhesion | 41 |
| % Cure (Top Surface) | 96.1 |
| % Cure (Bottom Surface) | Film cannot be peeled |

Table 5 provides examples of a cyan ink cured with UVI-6992 exhibiting low viscosity between the ranges of 4.3 to 4.9 cps at 25° C. The formulations derived from mono functional acrylate, such as SR 506 and SR 256, in a blend of vinyl ethers, are shown below. These inks were cured with UVI-6992 a cationic photoinitiator derived from triarylsulfonium hexafluorophosphate salts in propylene carbonate.

TABLE 5
Formulation of Low Viscosity Cyan Ink Cured with UVI-6992

| Raw Material | N11 | N12 | N13 | N14 |
|---|---|---|---|---|
| Triethyleneglycol Divinylether | 65.2 | 65.2 | 68.9 | 68.9 |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| Mixed Aryl sulfonium hexafluoro | 4 | 4 | 4 | 4 |
| phosphate salt (UVI-6992) | | | | |
| Isopropylthioxanthone | 1 | 1 | 1 | 1 |
| (ITX) | | | | |
| Cyan Dispersion NN-BBD15-1 | 11.2 | 11.2 | 7.5 | 7.5 |
| (20% Cyan Pigment in tripropylene | | | | |
| glycol diacrylate) | | | | |
| Total | 100.00 | 100.00 | 100.00 | 100.00 |
| Viscosity at 25° C. | 4.7 | 4.9 | 4.5 | 4.3 |

Table 6 provides examples of film properties for cyan inks cured with UVI-6992 using a 300 Watt/in mercury vapor lamp at a dose of 700 mJ/cm2 via Hanovia cure unit. N12 was exemplary in terms of cross hatch adhesion on polycarbonate, polyester, as well as both over flexible and rigid polyvinyl chloride substrates. The degree of cure was determined for the top surfaces on all inks and also the bottom surfaces, except for the black ink, by monitoring the vinyl ether peak at about 1640 cm⁻¹. The films upon cure were tack free. The solvent resistance was determined via the MEK rub test. Except for the polycarbonate substrate, all other plastic substrates provided moderate level of chemical resistance.

TABLE 6
Film Properties for Cyan Ink Formulation Cured with UVI-6992

| Film Properties | N11 | N12 | N13 | N14 |
|---|---|---|---|---|
| Surface tack (PET) | Tack free | Tack free | Tack free | Tack free |
| MEK Rubs over Polyvinyl chloride (PVC) | 5 | 7 | 15 | 5 |
| MEK Rubs over Flexible Vinyl | 2 | 2 | 6 | 6 |
| MEK Rubs over Polycarbonate (PC) | 0 | 0 | 0 | 0 |
| MEK Rubs over Polyester (PET) | 8 | 9 | 22 | 37 |
| X-hatch Adhesion over PVC | 35 | 44 | 3 | 26 |
| X-hatch Adhesion over Flexible Vinyl | 42 | 49 | 49 | 38 |
| X-hatch Adhesion over PC | 49 | 49 | 49 | 49 |
| X-hatch Adhesion over PET | 49 | 49 | 49 | 49 |
| % Cure (Top Surface) Vinyl ether | 93.9% | 96.3% | 97.1% | 96.9% |
| % Cure (Bottom Surface) Vinyl ether | 95.8% | 94.7% | 96.1% | 95.8% |

Table 7 provides examples of magenta ink cured with UVI-6992 exhibiting low viscosity between the ranges of 4.6 to 5.0 cps at 25° C. The formulations derived from mono functional acrylate, such as SR 506 and SR 256, in a blend of vinyl ethers are shown below. These inks were cured with UVI-6992, a cationic photoinitiator derived from triarylsulfonium hexafluorophosphate salts in propylene carbonate.

TABLE 7
Formulation of Low Viscosity Magenta Ink Cured with UVI-6992

| Raw Material | N15 | N16 | N17 | N18 |
|---|---|---|---|---|
| Triethyleneglycol Divinylether | 65.2 | 65.2 | 68.9 | 68.9 |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| Mixed Aryl sulfonium hexafluoro | 4 | 4 | 4 | 4 |
| phosphate salt (UVI-6992) | | | | |
| Isopropylthioxanthone | 1 | 1 | 1 | 1 |
| (ITX) | | | | |
| Magneta Dispersion NN-MCC08-1 | 11.2 | 11.2 | 7.5 | 7.5 |
| (20% Magenta Pigment in | | | | |
| tripropylene glycol diacrylate) | | | | |
| Total | 100.00 | 100.00 | 100.00 | 100.00 |
| Viscosity at 25° C. | 4.8 | 5.0 | 4.7 | 4.6 |

Table 8 provides examples of film properties for magenta inks cured with UVI-6992 using a 300 Watt/in mercury vapor lamp at a dose of 700 mJ/cm2 via Hanovia cure unit. N16 was exemplary in terms of cross hatch adhesion on polycarbonate, polyester, as well as both over flexible and rigid polyvinyl chloride substrates. The degree of cure was determined for the top surfaces on all inks, and also the bottom surfaces, except for the black ink, by monitoring the vinyl ether peak at about 1640 cm⁻¹. The films upon cure were tack free. The solvent resistance was determined via the MEK rub test. Except the polycarbonate substrate, all other plastic substrates provided moderate level of chemical resistance.

TABLE 8
Film Properties for Magenta Ink Formulation Cured with UVI-6992

| Film Properties | N15 | N16 | N17 | N18 |
|---|---|---|---|---|
| Surface tack (PET) | Tack free | Tack free | Tack free | Tack free |
| MEK Rubs over Polyvinyl chloride | 4 | 16 | 10 | 6 |
| (PVC) | | | | |
| MEK Rubs over Flexible Vinyl | 2 | 2 | 3 | 3 |
| MEK Rubs over Polycarbonate (PC) | 0 | 0 | 0 | 0 |
| MEK Rubs over Polyester (PET) | 4 | 7 | 23 | 8 |
| X-hatch Adhesion over PVC | 49 | 49 | 12 | 41 |
| X-hatch Adhesion over Flexible Vinyl | 49 | 49 | 49 | 48 |
| X-hatch Adhesion over PC | 49 | 49 | 49 | 49 |
| X-hatch Adhesion over PET | 49 | 49 | 49 | 49 |
| % Cure (Top Surface) Vinyl ether | 92.6% | 88.9% | 91.9% | 89.1% |
| % Cure (Bottom Surface) Vinyl ether | 72.9% | 73.2% | 92.9% | 93.2% |

Table 9 provides examples of yellow ink cured with UVI-6992 exhibiting low viscosity between the ranges of 4.3 to 4.7 cps at 25° C. The formulations derived from mono functional acrylate, such as SR 506 and SR 256, in a blend of vinyl ethers, are shown below. These inks were cured with UVI-6992 a cationic photoinitiator derived from triarylsulfonium hexafluorophosphate salts in propylene carbonate.

TABLE 9
Formulation of low viscosity Yellow ink cured with UVI-6992

| Raw Material | N19 | N20 | N21 | N22 |
|---|---|---|---|---|
| Triethyleneglycol Divinylether | 65.2 | 65.2 | 68.9 | 68.9 |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| Mixed Aryl sulfonium hexafluoro | 4 | 4 | 4 | 4 |
| phosphate salt (UVI-6992) | | | | |
| Isopropylthioxanthone | 1 | 1 | 1 | 1 |
| (ITX) | | | | |
| Yellow Dispersion NN-YDF09-1 | 11.2 | 11.2 | 7.5 | 7.5 |
| (20% Yellow Pigment in | | | | |
| tripropylene glycol diacrylate) | | | | |
| Total | 100.00 | 100.00 | 100.00 | 100.00 |
| Viscosity at 25° C. | 4.7 | 4.7 | 4.4 | 4.3 |

Table 10 provides examples of film properties for yellow inks cured with UVI-6992 using a 300 Watt/in mercury vapor lamp at a dose of 700 mJ/cm2 via Hanovia cure unit. N20 was exemplary in terms of cross hatch adhesion on polycarbonate, polyester, as well as both over flexible and rigid polyvinyl chloride substrates. The degree of cure was determined for the top surfaces on all inks and also the bottom surfaces, except for the black ink, by monitoring the vinyl ether peak at about 1640 cm⁻¹. The films upon cure were tack free. The solvent resistance was determined via the MEK rub test. Except the polycarbonate substrate, all other plastic substrates provided moderate level of chemical resistance.

TABLE 10
Film Properties for Yellow Ink Formulation Cured with UVI-6992

| Film Properties | N19 | N20 | N21 | N22 |
|---|---|---|---|---|
| Surface tack (PET) | Tack free | Tack free | Tack free | Tack free |
| MEK Rubs over Polyvinyl chloride | 5 | 43 | 100 | 15 |
| (PVC) | | | | |
| MEK Rubs over Flexible Vinyl | 2 | 3 | 6 | 3 |
| MEK Rubs over Polycarbonate (PC) | 0 | 0 | 0 | 0 |
| MEK Rubs over Polyester (PET) | 7 | 9 | 24 | 42 |
| X-hatch Adhesion over PVC | 47 | 49 | 22 | 15 |
| X-hatch Adhesion over Flexible Vinyl | 49 | 49 | 47 | 45 |
| X-hatch Adhesion over PC | 49 | 49 | 49 | 49 |
| X-hatch Adhesion over PET | 49 | 49 | 49 | 49 |
| % Cure (Top Surface) Vinyl ether | 94.4% | 94.9% | 95.7% | 94.9% |
| % Cure (Bottom Surface) Vinyl ether | 92.1% | 93.6% | 97.5% | 96.2% |

Table 11 provides examples of black ink cured with UVI-6992 exhibiting low viscosity between the ranges of 3.8 to 5.7 cps at 25° C. The formulations derived from mono functional acrylate, such as SR 506 and SR 256, in a blend of vinyl ethers, are shown below. These inks were cured with UVI-6992, a cationic photoinitiator derived from triarylsulfonium hexafluorophosphate salts in propylene carbonate.

TABLE 11
Formulation of Low Viscosity Black Ink Cured with UVI-6992

| Raw Material | N23 | N24 | N25 | N26 |
|---|---|---|---|---|
| Triethyleneglycol Divinylether | 65.2 | 65.2 | 68.9 | 68.9 |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| Mixed Aryl sulfonium hexafluoro | 4 | 4 | 4 | 4 |
| phosphate salt (UVI-6992) | | | | |
| Isopropylthioxanthone | 1 | 1 | 1 | 1 |
| (ITX) | | | | |
| Black Dispersion NN-KKA07-1 | 11.2 | 11.2 | 7.5 | 7.5 |
| (20% Black Pigment in | | | | |
| tripropylene glycol diacrylate) | | | | |
| Total | 100.00 | 100.00 | 100.00 | 100.00 |
| Viscosity at 25° C. | 5.7 | 5.2 | 4.4 | 3.8 |

Table 12 provides examples of film properties for black inks cured with UVI-6992 using a 300 Watt/in mercury vapor lamp at a dose of 700 mJ/cm2 via Hanovia cure unit. N24 was exemplary in terms of cross hatch adhesion on polycarbonate, polyester, as well as both over flexible and rigid polyvinyl chloride substrates. The degree of cure was determined for the top surfaces on all inks and also the bottom surfaces, except for the black ink, by monitoring the vinyl ether peak at about 1640 cm⁻¹. The films upon cure were tack free. The solvent resistance was determined via the MEK rub test. Except the polycarbonate substrate, all other plastic substrates provided moderate level of chemical resistance.

TABLE 12
Film Properties for Black Ink Formulation Cured with UVI-6992

| Film Properties | N23 | N24 | N25 | N26 |
|---|---|---|---|---|
| Surface tack (PET) | Tack | Tack | Tack | Tack |
| | free | free | free | free |
| MEK Rubs over Polyvinyl chloride | 2 | 5 | 30 | 6 |
| (PVC) | | | | |
| MEK Rubs over Flexible Vinyl | 1 | 2 | 3 | 2 |
| MEK Rubs over Polycarbonate | 1 | 1 | 1 | 1 |
| (PC) | | | | |
| MEK Rubs over Polyester (PET) | 2 | 3 | 23 | 9 |
| X-hatch Adhesion over PVC | 49 | 49 | 12 | 49 |
| X-hatch Adhesion over Flexible | 49 | 49 | 49 | 49 |
| Vinyl | | | | |
| X-hatch Adhesion over PC | 49 | 49 | 49 | 49 |
| X-hatch Adhesion over PET | 49 | 49 | 49 | 49 |
| % Cure (Top Surface) Vinyl ether | 97.0% | 97.5% | 95.5% | 90.4% |
| % Cure (Bottom Surface) Vinyl | CD | CD | CD | CD |
| ether | | | | |

Table 13 provides examples of cyan inks cured with Igacure 250 exhibiting low viscosity between the ranges of 4.4 to 6.3 cps at 25° C. The formulations derived from mono functional acrylate, such as SR 506 and SR 256, in a blend of vinyl ethers, are shown below. These inks were cured with Irgacure 250, a cationic photoinitiator derived from Iodonium (4-methylphenyl)[4-(2-methylpropyl)phenyl]-, hexafluorophosphate salt in propylene carbonate.

TABLE 13
Formulation for Low Viscosity Cyan Ink Cured with Irgacure 250

| Raw Material | N27 | N28 | N29 | N30 |
|---|---|---|---|---|
| Triethyleneglycol Divinylether | 65.2 | 65.2 | 68.9 | 68.9 |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane (BYK 377) | | | | |
| Methyl benzoylformate | 3.5 | 3.5 | 3.5 | 3.5 |
| (Genocure MBF) | | | | |
| iodonium, (4-methylphenyl)[4-(2- | 4 | 4 | 4 | 4 |
| methylpropyl) phenyl]-, | | | | |
| hexafluorophosphate(1-) | | | | |
| (Irgacure 250) | | | | |
| Isopropylthioxanthone | 1 | 1 | 1 | 1 |
| (ITX) | | | | |
| Cyan Dispersion NN-BBD15-1 | 11.2 | 11.2 | 7.5 | 7.5 |
| (20% Cyan Pigment in | | | | |
| tripropylene glycol diacrylate) | | | | |
| Total | 100.00 | 100.00 | 100.00 | 100.00 |
| Viscosity at 25° C. | 6.3 | 4.5 | 4.4 | 4.6 |

Table 14 provides examples of film properties for cyan inks cured with Irgacure 250 using a 300 Watt/in mercury vapor lamp at a dose of 700 mJ/cm2 via Hanovia cure unit. Cyan inks cured with Irgacure 250 provided better physical properties such as cross hatch adhesion and solvent resistance compared to the Cyan ink cured with UVI-6992. Formulas N28 and N29, containing SR 506, provided exemplary film properties over plastic substrates. The films upon cure were tack free.

TABLE 14
Film Properties for Cyan Ink Formulation Cured with Irgacure 250

| Film Properties | N27 | N28 | N29 | N30 |
|---|---|---|---|---|
| Surface tack (PET) | Tack free | Tack free | Tack free | Tack free |
| MEK Rubs over Polyvinyl chloride | 18 | 100 | 100 | 14 |
| (PVC) | | | | |
| MEK Rubs over Flexible Vinyl | 22 | 23 | 13 | 18 |
| MEK Rubs over Polycarbonate (PC) | 0 | 28 | 11 | 0 |
| MEK Rubs over Polyester (PET) | 12 | 25 | 24 | 12 |
| X-hatch Adhesion over PVC | 17 | 49 | 49 | 7 |
| X-hatch Adhesion over Flexible Vinyl | 28 | 48 | 49 | 48 |
| X-hatch Adhesion over PC | 49 | 49 | 11 | 49 |
| X-hatch Adhesion over PET | 49 | 49 | 49 | 49 |
| % Cure (Top Surface) Vinyl ether | NP | NP | NP | NP |
| % Cure (Bottom Surface) Vinyl ether | CD | CD | CD | CD |

Table 15 provides examples of magenta inks cured with Igacure 250 exhibiting low viscosity between the ranges of 4.6 to 8.2 cps at 25° C. The formulations derived from mono functional acrylate, such as SR 506 and SR 256, in a blend of vinyl ethers are shown below. These inks were cured with Irgacure 250, a cationic photoinitiator derived from Iodonium (4-methylphenyl)[4-(2-methylpropyl)phenyl]-, hexafluorophosphate salt in propylene carbonate.

TABLE 15
Formulation for Low Viscosity Magenta Ink Cured with Irgacure 250

| Raw Material | N31 | N32 | N33 | N34 |
|---|---|---|---|---|
| Triethyleneglycol | 65.2 | 65.2 | 68.9 | 68.9 |
| Divinylether | | | | |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| iodonium, (4- | 4 | 4 | 4 | 4 |
| methylphenyl)[4-(2- | | | | |
| methylpropyl) phenyl]-, | | | | |
| hexafluorophosphate(1-) | | | | |
| (Irgacure 250) | | | | |
| Isopropylthioxanthone | 1 | 1 | 1 | 1 |
| (ITX) | | | | |
| Magneta Dispersion NN- | 11.2 | 11.2 | 7.5 | 7.5 |
| MCC08-1 (20% Magenta | | | | |
| Pigment in tripropylene | | | | |
| glycol diacrylate) | | | | |
| Total | 100.00 | 100.00 | 100.00 | 100.00 |
| Viscosity at 25° C. | 4.6 | 8.2 | 6.0 | 5.0 |

Table 16 provides examples of film properties for magenta inks cured with Irgacure 250 using a 300 Watt/in mercury vapor lamp at a dose of 700 mJ/cm2 via Hanovia cure unit. Magenta inks cured with Irgacure 250 provided better physical properties such as cross hatch adhesion and solvent resistance compared to the Magenta ink cured with UVI-6992. Formulas N32 and N33, containing SR 506, provided exemplary film properties over plastic substrates. The films upon cure were tack free.

TABLE 16
Film Properties for Magenta Ink Formulation Cured with Irgacure 250

| Film Properties | N31 | N32 | N33 | N34 |
|---|---|---|---|---|
| Surface tack (PET) | Tack free | Tack free | Tack free | Tack |
| | | | | free |
| MEK Rubs over Polyvinyl | 12 | 100 | 100 | 15 |
| chloride (PVC) | | | | |
| MEK Rubs over Flexible | 23 | 14 | 54 | 10 |
| Vinyl | | | | |
| MEK Rubs over | 9 | 24 | 28 | 11 |
| Polycarbonate (PC) | | | | |
| MEK Rubs over Polyester | 15 | 28 | 34 | 20 |
| (PET) | | | | |
| X-hatch Adhesion over PVC | 49 | 49 | 49 | 16 |
| X-hatch Adhesion over | 48 | 48 | 49 | 49 |
| Flexible Vinyl | | | | |
| X-hatch Adhesion over PC | 49 | 49 | 49 | 49 |
| X-hatch Adhesion over PET | 49 | 49 | 49 | 49 |
| % Cure (Top Surface) Vinyl | NP | NP | NP | NP |
| ether | | | | |
| % Cure (Bottom Surface) | CD | CD | CD | CD |
| Vinyl ether | | | | |

Table 17 provides examples of yellow inks cured with Igacure 250 exhibiting low viscosity between the ranges of 5.3 to 8.0 cps at 25° C. The formulations derived from mono functional acrylate, such as SR 506 and SR 256, in a blend of vinyl ethers are shown below. These inks were cured with Irgacure 250, a cationic photoinitiator derived from Iodonium (4-methylphenyl)[4-(2-methylpropyl)phenyl]-, hexafluorophosphate salt in propylene carbonate.

TABLE 17
Formulation for Low Viscosity Yellow Ink Cured with Irgacure 250

| Raw Material | N35 | N36 | N37 | N38 |
|---|---|---|---|---|
| Triethyleneglycol | 65.2 | 65.2 | 68.9 | 68.9 |
| Divinylether | | | | |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| iodonium, (4- | 4 | 4 | 4 | 4 |
| methylphenyl)[4-(2- | | | | |
| methylpropyl) phenyl]-, | | | | |
| hexafluorophosphate(1-) | | | | |
| (Irgacure 250) | | | | |
| Isopropylthioxanthone | 1 | 1 | 1 | 1 |
| (ITX) | | | | |
| Yellow Dispersion NN- | 11.2 | 11.2 | 7.5 | 7.5 |
| YDF09-1 (20% Yellow | | | | |
| Pigment in tripropylene | | | | |
| glycol diacrylate) | | | | |
| Total | 100.00 | 100.00 | 100.00 | 100.00 |
| Viscosity at 25° C. | 8.0 | 6.8 | 5.6 | 5.3 |

Table 18 provides examples of film properties for yellow inks cured with Irgacure 250 using a 300 Watt/in mercury vapor lamp at a dose of 700 mJ/cm2 via Hanovia cure unit. Yellow inks cured with Irgacure 250 provided better physical properties such as cross hatch adhesion and solvent resistance compared to the yellow ink cured with UVI-6992. Formulas N36 and N37, containing SR 506, provided exemplary film properties over plastic substrates. The films upon cure were tack free.

TABLE 18
Film Properties for Yellow Ink Formulation Cured with Irgacure 250

| Film Properties | N35 | N36 | N37 | N38 |
|---|---|---|---|---|
| Surface tack (PET) | Tack | Tack free | Tack | Tack |
| | free | | free | free |
| MEK Rubs over Polyvinyl chloride | 9 | 100 | 100 | 9 |
| (PVC) | | | | |
| MEK Rubs over Flexible Vinyl | 33 | 65 | 77 | 39 |
| MEK Rubs over Polycarbonate (PC) | 15 | 25 | 42 | 16 |
| MEK Rubs over Polyester (PET) | 15 | 33 | 34 | 19 |
| X-hatch Adhesion over PVC | 34 | 49 | 49 | 16 |
| X-hatch Adhesion over Flexible Vinyl | 49 | 49 | 49 | 49 |
| X-hatch Adhesion over PC | 49 | 49 | 49 | 49 |
| X-hatch Adhesion over PET | 49 | 49 | 49 | 49 |
| % Cure (Top Surface) Vinyl ether | NP | NP | NP | NP |
| % Cure (Bottom Surface) Vinyl ether | CD | CD | CD | CD |

Table 19 provides examples of black inks cured with Igacure 250 exhibiting low viscosity between the ranges of 4.4 to 5.7 cps at 25° C. The formulations derived from mono functional acrylate, such as SR 506 and SR 256, in a blend of vinyl ethers are shown below. These inks were cured with Irgacure 250, a cationic photoinitiator derived from Iodonium (4-methylphenyl)[4-(2-methylpropyl)phenyl]-, hexafluorophosphate salt in propylene carbonate.

TABLE 19
Formulation for Low Viscosity Black Ink Cured with Irgacure 250

| Raw Material | N39 | N40 | N41 | N42 |
|---|---|---|---|---|
| Triethyleneglycol Divinylether | 65.2 | 65.2 | 68.9 | 68.9 |
| (Rapicure DVE-3) | | | | |
| 4-Hydroxybutylvinylether | 5 | 5 | 5 | 5 |
| (Rapicure 4-HBVE) | | | | |
| isobornyl acrylate | | 10 | 10 | |
| (SR 506) | | | | |
| ethyl acrylate | 10 | | | 10 |
| (SR 256) | | | | |
| Polyether modified | 0.1 | 0.1 | 0.1 | 0.1 |
| polydimethylsiloxane | | | | |
| (BYK 377) | | | | |
| Methyl benzoylformate | 3.5 | 3.5 | 3.5 | 3.5 |
| (Genocure MBF) | | | | |
| iodonium, (4-methylphenyl)[4-(2- | 4 | 4 | 4 | 4 |
| methylpropyl) phenyl]-, | | | | |
| hexafluorophosphate(1-) | | | | |
| (Irgacure 250) | | | | |
| Isopropylthioxanthone | 1 | 1 | 1 | 1 |
| (ITX) | | | | |
| Black Dispersion NN-KAA07-1 | 11.2 | 11.2 | 7.5 | 7.5 |
| (20% Black Pigment in | | | | |
| tripropylene glycol diacrylate) | | | | |
| Total | 100.00 | 100.00 | 100.00 | 100.00 |
| Viscosity at 25° C. | 5.4 | 5.2 | 4.4 | 5.7 |

Table 20 provides examples of film properties for black inks cured with Irgacure 250 using a 300 Watt/in mercury vapor lamp at a dose of 700 mJ/cm2 via Hanovia cure unit. Black inks cured with Irgacure 250 provided better physical properties such as cross hatch adhesion and solvent resistance compared to the Black ink cured with UVI-6992. Formulas N40 and N41, containing SR 506, provided exemplary film properties over plastic substrates. The films upon cure were tack free.

TABLE 20
Film Properties for Black Ink Formulation Cured with Irgacure 250

| Film Properties | N39 | N40 | N41 | N42 |
|---|---|---|---|---|
| Surface tack (PET) | Tack free | Tack | Tack free | Tack |
| | | free | | free |
| MEK Rubs over Polyvinyl chloride | 6 | 100 | 100 | 6 |
| (PVC) | | | | |
| MEK Rubs over Flexible Vinyl | 4 | 9 | 14 | 9 |
| MEK Rubs over Polycarbonate | 3 | 19 | 19 | 10 |
| (PC) | | | | |
| MEK Rubs over Polyester (PET) | 13 | 28 | 34 | 17 |
| X-hatch Adhesion over PVC | 43 | 37 | 49 | 28 |
| X-hatch Adhesion over Flexible | 45 | 47 | 47 | 26 |
| Vinyl | | | | |
| X-hatch Adhesion over PC | 49 | 49 | 49 | 49 |
| X-hatch Adhesion over PET | 49 | 49 | 49 | 49 |
| % Cure (Top Surface) Vinyl ether | NP | NP | NP | NP |
| % Cure (Bottom Surface) Vinyl | CD | CD | CD | CD |
| ether | | | | |

While numerous changes may be made by those skilled in the art, such changes are encompassed within the spirit and scope of this invention as defined by the appended claims.

I claim:

1. A low viscosity ink formulation comprising a vinyl ether component, a mono-acrylate component, a photocation polymerization initiator, and a free-radical photoinitiator, wherein the low viscosity ink formulation is free of epoxy functional monomer.

2. The low viscosity ink formulation of claim 1 in which the vinyl ether component is selected from the group consisting of ethylene glycol divinyl ether, triethylene glycol divinyl ether, trimethylolpropane trivinyl ether, triethylene glycol monobutyl ether, cyclohexanedimethanol divinyl ether, hydroxybutyl vinyl ether, dodecyl vinyl ether, propenyl ether propylene carbonate, methyl vinyl ether, ethyl vinyl ether, propyl vinyl ether, isobutyl vinyl ether, ethylene glycol monovinyl ether, diethylene glycol divinyl ether, butanediol divinyl ether, hexanediol divinyl ether, cyclohexanedimethanol monovinyl ether, cyclohexyl vinyl ether, 2-chloroethyl vinyl ether, 2-hydroxyethyl vinyl ether, diethylene glycol divinyl ether, 2,2-bis(4-vinyloxyethoxyphe-nyl)propane, 1,4-bis(2-vinyloxyethoxy)benzene ethyleneglycol monovinyl ether, ethyl vinyl ether, isobutyl vinyl ether, 1,6-hexanediol divinyl ether, aminopropyl vinyl ether, tert-amyl vinyl ether, butanediol divnyl ether, n-butyl vinyl ether, tert-butyl vinyl ether, cyclohexanedimethanol divinyl ether, cyclohexanedimethanol monovinyl ether, cyclohexyl vinyl ether, diethylaminoethyl vinyl ether, diethyleneglycol divinyl ether, diethyleneglycol monovinyl ether, dodeccyl vinyl ether, ethyleneglycol butyl vinyl ether, ethyleneglycol divinyl ether, ethylhexyl vinyl ether, hexanediol divinyl ether, 4-hydroxybutyl vinyl ether, isopropyl vinyl ether, octadecyl vinyl ether, polyethyleneglycol-520 methyl vinyl ether, polytetrahydrofurandivinyl ether, plurio-E200 divinyl ether, n-propyl vinyl ether, tetraethyleneglycol divinyl ether, triethyleneglycol divinyl ether, triethyleneglycol methyl vinyl ether, and trimethylolpropane trivinyl ether, hydroxylethyl vinyl ether, diethylene glycol divinyl ether, and combinations thereof.

3. The low viscosity ink formulation of claim 1 wherein the mono-acrylate component is selected from the group consisting of monofunctional acrylate ester, monofunctional acrylate ester, acrylic ester, acrylic ester, acrylic monomer, 2-phenoxy ethyl acrylate, cyclic trimethyolpropane formal acrylate, isodecyl acrylate, lauryl acrylate, tridecyl acrylate, stearyl acrylate, 2(2-ethoxyethoxy) ethyl acrylate, isooctyl acrylate, tetrahydro furfuryl acrylate, methyl acrylate, ethyl acrylate, isopropyl acrylate, n-hexyl acrylate, allyl acrylate, 2-(2′-vinyloxy ethoxy)ethyl acrylate and combinations thereof.

4. The low viscosity ink formulation of claim 1 wherein the vinyl ether component is selected from the group consisting of 3,6,9,12-tetraoxatetradeca-1,13-diene, 4-hydroxybutyl vinyl ether and combinations mixture thereof.

5. The low viscosity ink formulation of claim 1 wherein the mono-acrylate component is selected the group consisting of 2-(2′-vinyloxy ethoxy)ethyl acrylate, 2(2-ethoxyethoxy)ethyl acrylate, tetrahydrofurfuryl acrylate and combinations thereof.

6. The low viscosity ink formulation of claim 1 wherein the mono-acrylate component is isobornyl acrylate.

7. The low viscosity ink formulation of claim 1 wherein, based upon the weight of the ink formulation, the vinyl ether component is present in an amount of about 1 to about 85 wt %, the mono-acrylate component is present in an amount about 1 to about 40 wt %, the photocation polymerization initiator is present in an amount of about 0.5 to about 15 wt % the free-radical photoinitiator in an amount of about of about 0.5 to about 20 wt %,

8. The ink formulation of claim 1 having a viscosity between about 2 and about 10 cps at 25° C.

9. The ink formulation of claim 1 having a viscosity between about 2 and about 7 cps at 25° C.

10. The ink formulation of claim 1 wherein the formulation is an inkjet ink for drop-on-demand printheads.

11. The ink formulation of claim 1 wherein the vinyl ether component is a blend of trietheyleneglycol divinylether and 4-hydroxybutylvinylether.

12. The ink formulation of claim 1 wherein the photocation polymerization initiator is methyl benzoylformate combined with aryl sulfonium hexafluoro phosphate salt.

13. The ink formulation of claim 1 wherein the photocation polymerization initiator is methyl benzoylformate combined with iodonium, (4-methylphenyl)[4-(2-methylpropyl)phenyl]-, hexafluorophosphate(1-).

14. The ink formulation of claim 1 wherein the photocation polymerization initiator is methyl benzoylformate combined with mixed aryl sulfonium hexafluoro phosphate salt.

15. The ink formulation of claim 1 wherein the free-radical photoinitiator is isopropylthioxanthone.

16. A low viscosity ink formulation comprising a component containing both vinyl ether and acrylate functionality, a photocation polymerization initiator, and a free-radical photoinitiator, wherein the low viscosity ink formulation is free of epoxy functional monomer.
